(19) United States
(12) Patent Application Publication
(10) Pub. No.: US 2025/0244473 A1
(43) Pub. Date: Jul. 31, 2025

(54) SECURE FLASHLESS BOOTING FOR AUTOMOTIVE RADAR

(71) Applicant: NXP B.V., Eindhoven (NL)

(72) Inventors: Abdellatif Zanati, Hamburg (DE); Kannan Govindankutty Sreekumari Nambiar, Bangalore (IN); Eelke Strooisma, Grave (NL)

(21) Appl. No.: 18/617,400

(22) Filed: Mar. 26, 2024

(30) Foreign Application Priority Data
Jan. 29, 2024 (IN) 202441005666

(51) Int. Cl. G01S 13/931; H04L 9/32

(52) U.S. Cl. CPC G01S 13/931; H04L 9/32

(57) ABSTRACT

A radar system boots one or more radar sensors used in motor vehicles. Rather than storing software boot images, at different non-volatile memory (NVM) devices attached to each radar sensor module, the radar system supports booting of multiple radar sensors from the software boot images stored on the NVM device associated with a host. By booting multiple radar sensors with the boot images stored in a single NVM device, the overall number of NVM devices, and therefore the overall cost of the radar system, is reduced.

### CROSS-REFERENCE TO RELATED APPLICATIONS

This application claims priority under 35 U.S.C. § 119 to patent application no. 202441005666, filed Jan. 29, 2024, the contents of which are incorporated by reference herein.

### BACKGROUND

Motor vehicles with driving assistance capabilities including, for example, autonomous vehicles, use multiple sensors to detect data in an environment surrounding the vehicles. Examples of such sensors include, for example, radar, cameras, lidar, and the like. The data obtained from the environment is used by a processing unit of the autonomous vehicle to determine a course of action during movement of the motor vehicle, such as during driving, parking, turning, stopping, braking, and the like. During activation of the motor vehicle (e.g., during a startup process), the processing unit and the sensors undergo a boot process by executing a set of boot instructions set forth in stored software referred to as a boot image. The boot image is typically stored in a non-volatile memory (NVM) device attached to the sensors. However, this approach to booting radar sensor devices from an NVM device has high costs arising from the cost of the NVM and also due to, for example, the cost and area of the circuit board.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a radar sensor module containing a switch used to assist in booting the radar sensor module in accordance with some embodiments.

FIG. 2 is a block diagram of a radar sensor module containing a local host that assists in booting the radar sensor module in accordance with some embodiments.

FIG. 3 is a block diagram of a radar system to be used in a motor vehicle in accordance with some embodiments.

FIG. 4 is a plot of boot flow for a plurality of radar sensors in accordance with some embodiments.

FIG. 5 is a flow diagram of a method for security provisioning of a radar sensor in accordance with some embodiments.

FIG. 6 is a flow diagram of a method for booting a radar sensor in accordance with some embodiments.

### DETAILED DESCRIPTION

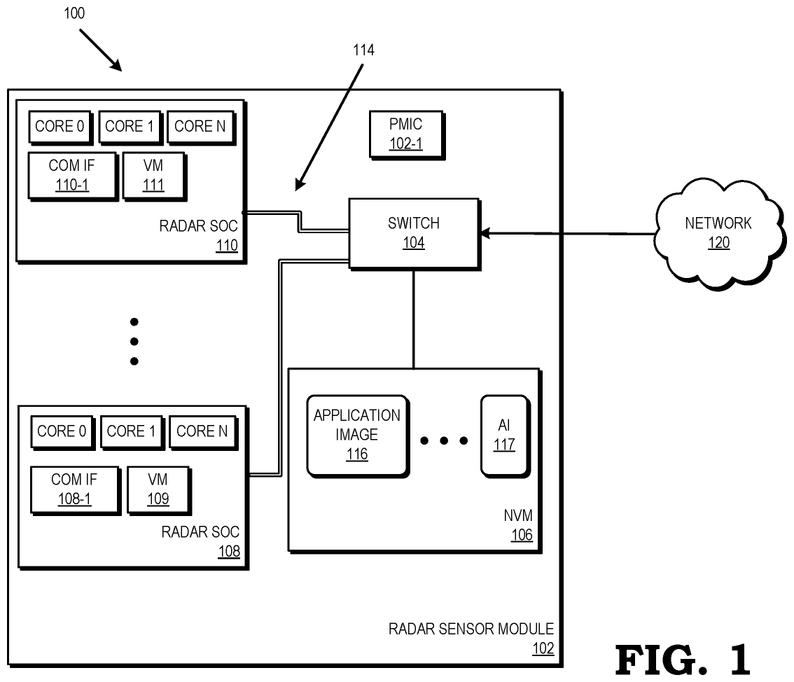

FIGS. 1-6 illustrate systems and techniques for booting one or more radar sensors used in motor vehicles, such as autonomous motor vehicles. Rather than storing application images at different non-volatile memory (NVM) devices attached to corresponding radar sensor modules, the techniques described herein support booting of multiple radar sensors from boot images stored on a single NVM device associated with a switch, a local host, or a remote host. By booting multiple radar sensors with the boot images stored in a single NVM device, rather than from local NVM devices directly connected to corresponding sensors, the overall number of NVM devices, and therefore the overall cost of the radar system, is reduced.

To illustrate via an example, some motor vehicles use a driving control system to control the motor vehicle. The control system provides at least partial autonomy (e.g., at least partial self-driving capability) for the motor vehicle. In order to provide these capabilities, the control system uses at least one sensor, such as a radar sensor, cameras, lidar, or other type of sensors, to detect objects in an environment around the motor vehicle. Moreover, in some embodiments, the control system includes advanced driver assistance systems (ADAS) to assist in collision avoidance and/or other driver assistance based on the objects detected by the sensors. For example, the control system receives data detected by the sensors to react to different situations including, for example, changes in traffic lights, arriving in range of a stop sign, adjusting motion or position of the motor vehicle based on surrounding vehicles, and the like. To provide acceptable safety margins and to enhance the user experience, it is desirable for the radar sensors to be operational for a substantial portion (e.g., more than 99%) of the time that the motor vehicle is being controlled by the control system. However, the radar sensors are not operational (e.g., do not provide reliable detection of objects) during the boot process. Accordingly, it is desirable to minimize the time required to boot the radar sensors.

One approach to achieving fast boot times for radar sensors is to have each radar sensor connected to a different NVM device located relatively close to the corresponding sensor, and to store the application image for a given sensor on the corresponding NVM device. However, this requires a relatively higher number of NVM devices, increasing system costs. Using the techniques described herein, one or more application images (e.g., boot images) are stored on the NVM device attached to a network switch (e.g., a gigabit switch) or a local host (e.g., a processing device connected to radar sensors on a common circuit board) that is connected to the multiple sensors or a remotely present host. The switch, local host, or the remote host manages booting the one or more radar sensor devices (sometimes referred to herein as simply “radar sensors” for brevity) using the application images stored in the NVM device. In particular, the switch, the local host, or the remote host operates as a hub or a host through which the application images are distributed to the one or more radar sensor devices. The radar sensor devices each store the application images at, and execute the corresponding instructions from, a corresponding volatile memory device (e.g., random access memory (RAM)) at the radar sensor device. This approach not only reduces the number of NVM devices employed for system booting, but improves the overall efficiency of updating and implementation of the software images for the different devices. Stated differently, instead of updating each radar sensor by sending the at least one application image to local NVM devices of the one or more radar sensors, the switch, the local host, or the remote host streamlines the process by providing a single non-volatile location to store the application images. Therefore, because a local NVM, or “flash”, device is not used for each radar sensor device, the host enables flashless booting of the one or more radar sensor devices.

In some embodiments, the one or more radar sensors in the motor vehicle employ a fast booting process to better support both safety and proper operation of the motor vehicle. For example, in some cases a boot time of two-hundred milliseconds (ms) supports both safety and proper vehicle operation. To achieve these fast boot times, the at least one application image is distributed in an efficient and time optimized manner, such as by distributing the image in serial or in parallel to the one or more radar sensors. Stated differently, the one or more radar sensors boot serially or boot in parallel in response to loading the at least one application image.

As highlighted above, the one or more radar sensors are used by the motor vehicle to improve operation by the control system. In addition to having consistent uptime, the one or more radar sensors are secured from outside interference. In other words, the one or more radar sensors implement countermeasures against unauthorized execution of, and access to, software images. For example, prior to placement of the one or more radar sensors into the motor vehicle, security provisioning is implemented to enable countermeasures against unauthorized execution of, and access to, application images. The security provisioning implements a security protocol that authenticates and optionally encrypts the application image prior to the image being provided to the one or more radar sensors. For example, during manufacturing of the one or more radar sensors, a cryptographic algorithm is used to encrypt the application image to protect the authenticity and optionally the confidentiality of the at least one software image. Stated differently, the key is required to allow access to the at least one application image for software updates and/or configuration changes to hardware.

FIG. 1 illustrates a block diagram of a radar system 100 to be used in a motor vehicle (not shown) and, in various embodiments, an autonomous motor vehicle. In the depicted example, the radar system 100 includes a radar sensor module (RSM) 102. Specifically, for example, the RSM 102 is a printed circuit board (PCB) consisting of several radar sensor System on Chips (SoCs). It will be appreciated that although only one RSM 102 is illustrated in FIG. 1, depending on a type of the motor vehicle, in some embodiments, there are a plurality of RSM 102. The RSM 102 is connected to a portion of the motor vehicle to provide environmental data surrounding the motor vehicle.

The radar system 100 includes a host, which in different embodiments represents a switch, a local host, or a remote host based on implementation. The host stores boot images. In the embodiment of FIG. 1, the host is a switch 104. In the depicted example, the RSM 102 includes a power management integrated circuit (PMIC) 102-1, the switch 104, a non-volatile memory (NVM) 106 (e.g., flash memory), and a plurality of radar sensors or System on Chips (SoCs) 108 and 110 (a.k.a., Integrated Circuit or IC). For brevity, the plurality of radar SoCs 108 and 110 will be referred to as the radar sensors 108 and 110. The PMIC 102-1 is an IC used for power management including, for example, voltage regulation, voltage scaling, power conversion, and the like. Moreover, the PMIC 102-1 manages power during loading of the at least one software image (sometimes referred to herein as an application image) on the radar sensors 108 and 110, respectively. The switch 104 controls and manages a booting process of the radar sensors 108 and 110 on the RSM 102. Moreover, in some embodiments, the switch 104 is a network switch. For example, the switch 104 is a gigabit switch that provides high speed data transfer. In the depicted example, the switch 104 is connected to the NVM 106 as a separate component. It will be appreciated that while the NVM 106 is illustrated as separate from the switch 104, in some embodiments, all or a portion of the NVM 106 is a part of the switch 104. In some embodiments, the switch 104 further includes a communication unit (not shown) including a network controller, a wire, an antenna, or a combination thereof that communicates over a communication link. In the context of the radar system 100, the communication link is a short-distance wired communication 114 (SDWC 114). The switch 104 is connected to (or otherwise in communication with) and controls access to any number and type of communication devices.

In the depicted example, the switch 104 is connected to the radar sensors 108 and 110 over the SDWC 114. The switch 104 transmits instructions and data to the radar sensors 108 and 110 and/or receives data from the radar sensors 108 and 110 over the SDWC 114. In particular, the switch 104 is connected to an NVM device 106 (e.g., a flash device or other non-volatile memory device) that stores a set of application images (e.g., application images 116 and 117). As used herein, the term application image (AI) refers to a boot image or other software image. The AIs 116 and 117 each include a corresponding set of software instructions to be executed by one or more of the radar sensors 108 and 110, and in some embodiments include an operating system, one or more software applications, and/or data that, when executed, facilitate operation one or more of the radar sensors 108 and 110. As will be described further below, in different embodiments the AIs 116 and 117 are a common distribution image (e.g., an image that includes instructions for operation of any radar sensor of the radar system 100), a device specific image (e.g., an image that includes instructions for operation of a specific one of the radar sensors based on hardware corresponding to the radar,).

For example, in some embodiments, each of the radar sensors 108 and 110 include similar capabilities, are to be configured in a similar manner, and are to be booted in a similar manner. In these embodiments, the AI 116 is a common distribution (CD) application image that consumes a relatively small amount of space at the NVM 106. In other embodiments, each of the radar sensors 108 and 110 include different capabilities, are to be configured in a different manner, are to be booted in a different manner, or any combination thereof. In these embodiments, the AI 116 and AI 117 are device specific (DS) images that together consume a relatively higher amount of space at the NVM 106. As described further below, the switch 104 is configured to distribute the AIs 116 and 117 to the radar sensors 108 and 110 via the SDWC 114. The particular image distributed to each of the radar sensors 108 and 110 depends on whether the radar system 100 is employing CD images, DS images, or a combination thereof, as described further herein.

Each of the plurality of radar sensors 108 and 110 is or includes a plurality of transmitters and receivers to send and receive radar signals. Each of the radar sensors 108 and 110 includes multiple core (multicore) processing units (e.g., Core 0, Core 1, Core N), such as central processing units (CPUs), graphics processing units (GPUs), multithreaded processing units, any other type of parallel processor, and the like. In the depicted example, only three cores are shown. However, in different embodiments, there are less cores or more cores than three. The multicore processing units of the radar sensors 108 and 110 are configured to execute sets of instructions (e.g., computer programs) that affect operation of the radar sensors 108 and 110. Additionally, in various embodiments, each of the plurality of radar sensors 108 and 110 include a volatile memory (VM) (e.g., static random-access memory (SRAM), tightly-coupled memory (TCM)) configured to temporarily receive and store the at least one application image from the switch 104 for execution by the multicore processing units. For example, the radar sensor 108 includes a VM 109 and the radar sensor 110 includes a VM 111.

In various embodiments, the radar sensor 108 includes a communication interface (COM IF) 108-1. Similarly, the radar sensor 110 includes a COM IF 110-1. In some embodiments, the COM IF 108-1 and the COM IF 110-1 are the physical layer specifications for Ethernet connections and transport data from the radar sensors 108 and 110 to the switch 104 over the SDWC 114. In some embodiments, the COM IF 108-1 and the COM IF 110-1 include a network controller, a wire, an antenna, or a combination thereof that facilitate communication over the SDWC 114. It will be appreciated that the number of components of the radar sensors 108 and 110 vary in some embodiments. In some embodiments, the radar sensors 108 and 110 include other components not shown in FIG. 1.

In operation, during a boot process for the radar system 100, the switch 100 sends one or more of the AIs 116 and 117 to the radar sensors 108 and 110. In response, each of the radar sensors 108 and 110 execute the instructions indicated by the received image in order to execute a corresponding boot process for the radar sensor. For example, in some embodiments the AIs 116 and 117 reflect boot instructions to initialize the hardware of the radar sensors, and thereby place each radar sensor in an operational state, such that the radar sensor is ready to execute specified radar operations, including generation of radar signals, detection of reflected radar signals, identification of objects and object characteristics, and the like. In response to receiving, via the network 120, a reset or other boot indication generated by, for example, an automotive system controller, the switch 104 retrieves one or more AIs from the NVM 106 and sends each retrieved AI to one or more of the radar sensors 108 and 110. In response, the radar sensors 108 and 110 store the received AI at the corresponding VM. The radar sensors 108 and 110 then execute the instructions reflected by the AI stored at the corresponding VM, thereby booting the sensor hardware. Thus, in the depicted embodiments the radar sensors 108 and 110 do not employ any local non-volatile memory that stores boot instructions, and thus do not boot from a local NVM. Instead, each of the radar sensors receives an AI from the switch 104, and uses the received AI to boot the sensor hardware from the corresponding VM.

After booting (that is, after the radar sensors 108 and 110 have executed the corresponding AI), the radar sensors 108 and 110 detect the surrounding environment around the motor vehicle during operation (e.g., driving, parking) of the motor vehicle to identify other vehicles and/or living organisms, behavior of other vehicles and/or living organisms, presence of objects (e.g., inanimate objects), and the like. In some embodiments, the environmental data identified by the radar sensors 108 and 110 is used to enhance safe operation of the motor vehicle. Furthermore, for motor vehicles that are autonomous, the radar sensors 108 and 110 are used by the control system to visualize the surrounding environment and react to a situation instead of receiving manual input from a driver. To illustrate, in order to operate autonomously, the motor vehicle relies on the environmental data from the radar sensors 108 and 110 to determine a course of action, as well as data detected by lidar and/or camera to identify the environmental data. The environmental data detected by the radar sensors 108 and 110, the lidar, and the camera are fused to provide accurate environmental data. For example, based on the environmental data from the radar sensors 108 and 110, the motor vehicle adjusts motion (e.g., forward movement, rearward movement) or position of the motor vehicle based on surrounding vehicles and/or objects, changing lanes, stopping at a traffic light or a stop sign, and the like.

As described above, in various embodiments, the switch 104 is connected over the SDWC 114 to the radar sensors 108 and 110. In various embodiments, the SDWC 114 used between the switch 104 and the radar sensors 108 and 110 is a communication interface, such as serial peripheral interface (SPI), controller area network (CAN), universal asynchronous receiver-transmitter (UART), camera serial interface (CSI), flexray, and the like. In various embodiments, the switch 104 is further connected to an external network 120, such as a network of the motor vehicle. Alternatively, the network 120 may be a network for a manufacturer or other originator for receipt of the at least one application image on the NVM 106.

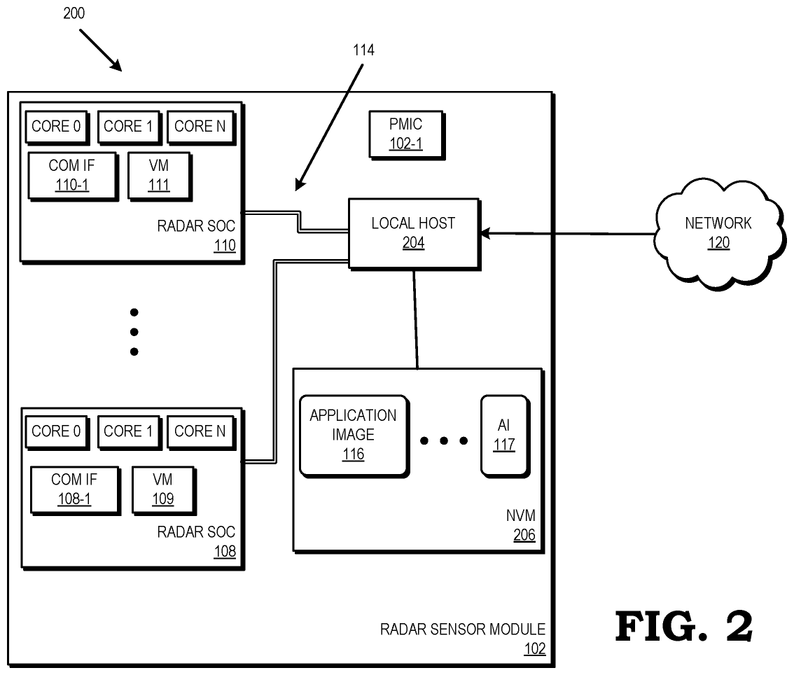

FIG. 2 illustrates a block diagram of a radar system 200 to be used in a motor vehicle (not shown) in accordance with some embodiments. The radar system 200 may implement or be implemented by aspects of the radar system 100 as described with reference to FIG. 1. In the embodiment of FIG. 2, the host is a local host 204. In the depicted example, the radar sensors 108 and 110 are connected to the local host 204. The local host 204 refers to a processing device connected to the radar sensor 108 and the radar sensor 110 on the same module, illustrated as the RSM 102. Specifically, in various embodiments, the local host 204 includes processing units such as central processing units (CPUs), graphics processing units (GPUs), application-specific integrated circuits (ASICs), field programmable gate arrays (FPGAs), and the like. In some embodiments, the local host 204 includes a plurality of different processing units, such as CPUs, GPUs, ASICs, and the like. In the depicted example, the local host 204 is connected to an NVM 206 as a separate component. It will be appreciated that while the NVM 206 is illustrated as separate from the local host 204, in some embodiments, all or a portion of the NVM 206 is a part of the local host 204. In some embodiments, the local host 204 further includes a communication unit (not shown) including a network controller, a wire, an antenna, or a combination thereof that communicates over the SWDC 114. The local host 204 is connected to (or otherwise in communication with) and controls access to any number and type of communication devices. In the depicted example, the local host 204 is connected to the radar sensors 108 and 110 over the SWDC 114. The local host 204 transmits instructions and data to the radar sensors 108 and 110 and/or receives data from the radar sensors 108 and 110 over the SWDC 114. For example, in some embodiments, the local host 204 transmits at least one application image to the radar sensors 108 and 110. The local host 204 stores the at least one application image within the NVM 206. As will be described further below, the at least one application image stored within the NVM 206 includes an image for the local host 204, a common distribution image, and/or a device specific image that is customized for the radar sensors 108 and 110.

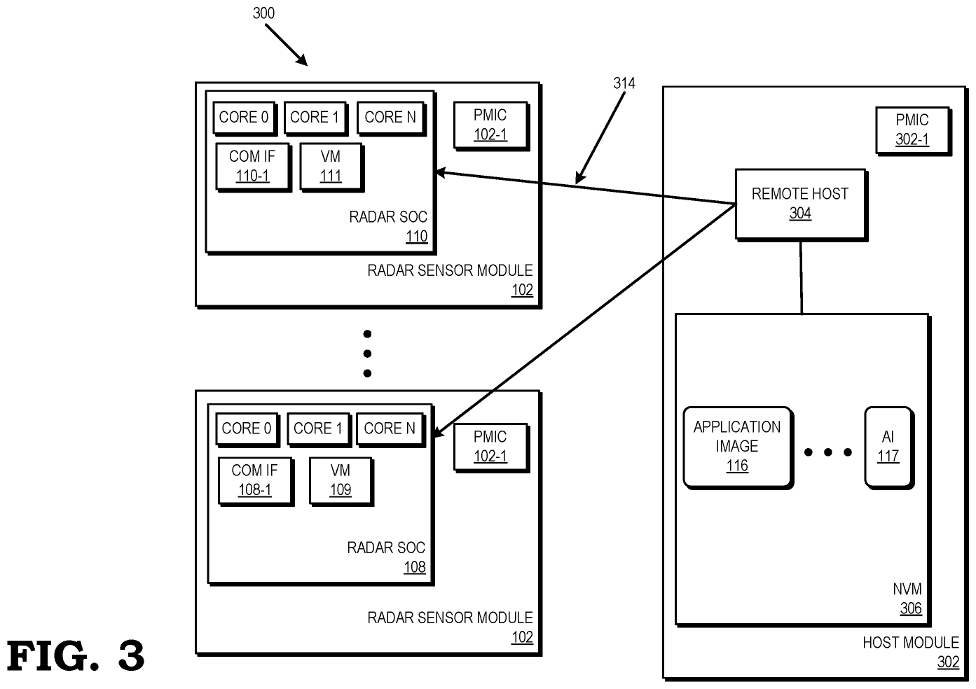

FIG. 3 illustrates a block diagram of a radar system 300 to be used in a motor vehicle (not illustrated) in accordance with some embodiments. The radar system 300 may implement or be implemented by aspects of the radar system 100 as described with reference to FIG. 1 and/or the radar system 200 as described with reference to FIG. 2. In the depicted example, the radar system 300 includes a host module (HM) 302. Specifically, for example, the HM 302 is a radar processing module. It will be appreciated that although only one radar system 300 is illustrated in FIG. 3, depending on a type of the motor vehicle, in some embodiments, there are a plurality of radar systems 300.

In the embodiment of FIG. 3, the host is a remote host 304. The HM 302 includes a power management integrated circuit (PMIC) 302-1, the remote host 304, and a non-volatile memory (NVM) 306. The PMIC 302-1 is an IC used for power management including, for example, voltage regulation, voltage scaling, power conversion, and the like. Moreover, the PMIC 302-1 manages power during retrieval of the at least one application image from the NVM 306.

The remote host 304 is remotely connected to the radar sensors 108 and 110 that are each disposed and/or integrated on individual RSM 102. The remote host 304 refers to a processing device connected to the radar sensors 108 and 110. Unlike the radar system 200, the remote host 304 is disposed on a separate module from the RSM 102. That is, in the depicted example, the HM 302 and the RSM 102 are separate modules. Specifically, in various embodiments, the remote host 304 includes processing units such as central processing units (CPUs), graphics processing units (GPUs), application-specific integrated circuits (ASICs), field programmable gate arrays (FPGAs), and the like. In some embodiments, the remote host 304 includes a plurality of different processing units, such as CPUs, GPUs, ASICs, and the like. The remote host 304 controls and manages a booting process of the radar sensors 108 and 110 on the RSMs 102. In the depicted example, the remote host 304 is connected to the NVM 306 as a separate component. It will be appreciated that while the NVM 306 is illustrated as separate from the remote host 304, in some embodiments, all or a portion of the NVM 306 is a part of the remote host 304. In some embodiments, the remote host 304 further includes a communication unit (not shown) including a network controller, a wire, an antenna, or a combination thereof that communicates over a communication link, such as a network 314. In the context of the radar system 300, the network 314 is an in-vehicle network (IVN), such as, for example, an Ethernet link. The remote host 304 is connected to (or otherwise in communication with) and controls access to any number and type of communication devices.

In the depicted example, the remote host 304 is connected to the radar sensors 108 and 110 over the network 314. The remote host 304 transmits instructions and data to the radar sensors 108 and 110 and/or receives data from the radar sensors 108 and 110 over the network 314. For example, in some embodiments, during booting the remote host 304 transmits at least one application image to the radar sensors 108 and 110. The remote host 304 stores the at least one application image within the NVM 306. As will be described further below, the at least one application image stored within the NVM 206 includes an image to be distributed by the remote host 304, such as a common distribution image, a device specific image that is customized for one or more of the radar sensors 108 and 110, or a combination thereof.

For purposes of description, the operations of the radar system 100, the radar system 200, and the radar system 300 are described with respect to an example implementation where one or more application images (AI) 116 and 117 are stored on the NVM 106 connected to the switch 104. However, in other embodiments, these operations are implemented at the radar system 200 and/or the radar system 300, wherein the one or more application images 116 and 117 are stored at the NVM 206 connected to the local host 204 of FIG. 2 or the remote host 304 of FIG. 3.

As described further below, by employing the remote host 304 to distribute application images from the NVM 206 to different radar sensors, the radar system 100 facilitates secure and efficient updating of sensor software. To illustrate, in some embodiments an initial version of the application images 116 and 117 are received by the switch over the external network 120 during a manufacture or initial configuration process, such as a configuration process conducted by a manufacturer. Moreover, after the radar system 100 has been placed into a vehicle and is in use (e.g., by a consumer or user) the switch 104 receives the one or more updated application images 116 and 117 over the external network 120, such as via software updates that add or update interference mitigation algorithms, modulation schemes, and/or multiple-input and multiple output (MIMO) schemes.

The switch 104 stores the one or more application images 116 and 117 within the NVM 106. The switch 104 tracks and/or identifies the one or more application images 116 and 117 as corresponding to common distribution (CD) application images, and/or device specific (DS) application images. For example, in some embodiments each of the AIs 116 and 117 includes a header, metadata, and the like, or any combination thereof that indicates whether the AI is a CD application image or a DS image. In the case of a DS image, the header and metadata can indicate (e.g., via a device identifier) which of the radar sensors 108 and 110 corresponds to the DS image (that is, which of the radar sensors 108 and 110 is to receive the DS image). Furthermore, in some embodiments, the header and metadata indicate whether the AI has been pre-encrypted (e.g., has been transmitted in encrypted form after encryption by a manufacturer or developer), or whether the AI is to be encrypted by the corresponding radar sensor using a corresponding encryption key. Based on the header and metadata, the switch 104 identifies each of the application images 116 and 117 as corresponding to the radar sensors 108 and 110.

As noted above, in different embodiments, the application images 116 and 117 is a common distribution (CD) application image or a device specific (DS) application image. A CD application image includes basic instructions that are common to the radar sensors 108 and 110. A DS application image includes instructions relating to specific operation of a corresponding radar sensor. In other words, a DS application image for the radar sensor 108 differs from a DS application image for the radar sensor 110. In some embodiments, a DS application image is tailored to specific hardware within the radar sensor 108 and/or the radar sensor 110. Furthermore, in some embodiments, a DS application image is encrypted with a device specific key. As such, in embodiments of the radar system 300 applying authentication or encryption for application images, the DS application images stored on the NVM 106 differs between each of the radar sensors 108, 110 because each of the DS application images is encrypted with a different corresponding encryption key. For example, applying encryption using the device specific key to the DS application image for the radar sensor 108 differs from a device specific key used to encrypt the DS application image for the radar sensor 110. Therefore, the DS application image offers more security because a key that has been compromised for one DS application image does not impact all other radar sensors.

In some embodiments, to ensure a secure operating environment between the switch 104 and the radar sensors 108 and 110, security provisioning is carried out on the radar sensors 108 and 110. The security provisioning process is implemented in a secure and trusted environment during manufacture or at a later time. Specifically, in some embodiments, the secure and trusted environment includes direct connections between the manufacturer device, the switch 104, and/or the radar sensors 108 and 110. For example, during the manufacturing process, the switch 104 and the radar sensors 108 and 110 are linked in a private and/or closed connection (e.g., network) that is not exposed to outside interference.

During the security provisioning process, the switch 104 and the radar sensors 108 and 110 undergo a handshake process in order to establish a connection. Subsequently, the switch 104 sends a security provisioning (SP) application image to each of the radar sensors 108 and 110. Additionally, the switch 104 sends the CD application image and/or the DS application image to the radar sensors 108 and 110 for verification (e.g., determine the images are appropriate for the radar sensor) and/or installation. Moreover, there are three different options for application images that are transferred from the switch 104 to the radar sensors 108 and 110. For each scenario, in some cases, none of the images are used, but in other cases, multiple images can be used based on security, performance, and/or memory space preferences. To identify the application image being sent from the switch 104 to the radar sensors 108 and 110, the switch 104 sends an image header that includes a filename, an identifier, and/or metadata that identifies whether the application image sent from the switch is the CD application image or the DS application image. For the first option, the CD application image is converted by, for example, the radar sensors 108 and/or 110, to a DS application image. In this scenario, a DS key is known only by the radar sensor and not a provider of the image. Upon conversion of the CD application image to the DS application image by the radar sensors 108 and/or 110, the DS application image is returned to the switch 104 for storage in the NVM 106. For the second option, the CD application is not converted based on user preferences. In this scenario, the radar sensor is less secure, but the image of the CD application image uses less space in the NVM 106. Additionally, only one of these images is stored in the NVM 106 which can be used for one or more of the radar sensors (e.g., radar sensor 108 and/or 110). Also, in this second option, the CD application image is transferred to the radar sensor 108 or 110 for authentication and verification by the radar sensor 108 and/or 110. However, these images are not returned to the switch 104. For the third option, the DS application images do not need conversion as they are already device specific. The switch 104 transfers the DS application images to the radar sensors 108 and/or 110 for authentication and verification. These images are not returned to the switch 104. At this time, the radar sensors 108 and 110 begin SP which includes analysis of hardware within the radar sensors 108 and 110 and determining of properties of the hardware that is specific to the radar sensors 108 or 110. For example, in some embodiments an SP application image determines configuration of hardware of the radar system, including the type of hardware, operating limits of the hardware, operating efficiency of the hardware, and the like. While the radar sensors 108 and 110 execute the SP, the switch 104 remains idle while waiting for updated information from the radar sensors 108 and 110.

In some embodiments, the application images 116 and 117 are secured using cryptographic methods, such as encryption (e.g., advanced encryption standard (AES), triple data encryption standard (triple DES), Rivest-Shamir-Adleman (RSA), and the like) and/or secure hash algorithms (SHA). In other words, the DS application images, each use an authentication and, optionally, an encryption scheme to secure the application images 116 and 117, associated with the radar sensor 108 or the radar sensor 110, respectively, which includes identification data of the radar sensors 108 and 110 determined during analysis of the corresponding hardware. In situations where the radar sensors 108 and/or 110 receive the CD application image and need to convert to a DS application image, a key (e.g., a secret, a public, or a private key is selected based on a type of cryptographic algorithm used) known only by the radar sensor 108 and 110 is used. Moreover, where the radar sensors 108 and/or 110 convert the CD application image to the DS application image, each key differs because the application images differ between the radar sensor 108 and the radar sensor 110. The radar sensors 108 and 110 optionally encrypt the CD application image for the CD application image that is converted to the DS application. In effect, the radar sensors 108 and 110 configure the CD application image to the DS application image based on a configuration of the radar sensors 108 and 110, respectively. Accordingly, the radar sensors 108 and 110 send the encrypted DS application image back to the switch 104. The switch 104 identifies the CD application image for the radar sensors 108 and 110, which are then stored in the NVM 106 as, for example, the AI 116. In other words, the NVM 106 stores the AI 116 that is the CD application image shared among the radar sensors 108 and 110. Alternatively, the NVM 106 stores the DS applications as the AI 116 or the AI 117 that is specific to the radar sensors 108 or 110, respectively. For example, the switch 104 identifies the AI 116 as the DS application image for operation of the radar sensor 108 and the AI 117 as the DS application image for operation of the radar sensor 110. Furthermore, the radar sensor 108 is not able to use any information or the AI 117 pertaining to the radar sensor 110, where the AI 117 is a DS application image. Conversely, the radar sensor 110 is not able to use any information or the AI 116 pertaining to the radar sensor 108, where the AI 116 is a DS application image. However, the radar sensors 108 and 110 both use the AI 117 and the AI 116, respectively, where a CD application image is used in both cases. It will be appreciated that the SP process described above is a one-time process and is only repeated during, for example, a application image update for at least one of the radar sensors 108 and 110 stored by the switch 104 on the NVM 106, such as a new software driver and/or new software features.

During operation of the autonomous motor vehicle, such as, for example, activation (i.e., turning on) of the autonomous motor vehicle, the switch 104 and the radar sensors 108 and 110 begin a booting process. The switch 104 and the radar sensors 108 and 110 initialize and begin a handshake process in order to establish a connection and the radar sensors 108 and 110 boot in response to loading of the AI 116 and/or the AI 117 from the NVM 106. Prior to extraction of the AI 116 and the AI 117 from the NVM 106, the switch 104 analyzes the AI 116 and the AI 117 to determine the AI 116 is configured for the radar sensor 108 and the AI 117 is configured for the radar sensor 110, based on the configuration established during the SP process, such as for DS application images. Alternatively, the switch 104 determines the AI 116 and the AI 117 are CD application images, then only a single image is used that is shared for the radar sensors 108 and 110, such as the AI 116 only. In response to identifying applications corresponding to the radar sensors 108 or 110, the switch 104 continues the booting process by transmitting the AI 116 and/or the AI 117 to the radar sensor 108 and the radar sensor 110, respectively. In this manner, the switch 104 facilitates flashless booting of the radar sensors 108 and 110, such that each of the radar sensors 108 and 110 boots without NVM connected directly to each of the radar sensors 108 and 110.

Upon receipt of the AI 116 by the radar sensor 108 and the AI 117 by the radar sensor 110, the radar sensors 108 and 110 authenticate and optionally decrypt the AI 116 and the AI 117, respectively. Each core of the multicore processing units of the radar sensors 108 and 110 initially authenticates and optionally decrypts the AI 116 and the AI 117, followed by execution of the AI 116 and the AI 117. The radar sensors 108 and 110 execute the AI 116 and the AI 117 to operate the radar related to the motor vehicle. Based on the techniques described herein, in some embodiments the total boot time of the radar sensors 108 and 110 is between 200 ms to 1 second(s).

Accordingly, as described herein, through the centralization of the booting process to the switch 104 instead of storing the AI 116 at the radar sensor 108 and storing the AI 117 at the radar sensor 110, there is substantial reduction in cost of development for the radar sensor 108 and the radar sensor 110. In particular, the radar sensor 108 and the radar sensor 110 do not need to each have memory to store the AI 116 and the AI 117, respectively. Also, the switch 104 sends the AI 116 and the AI 117 serially or in parallel, based on communication interface chosen, to the radar sensor 108 and 110, such that the radar sensors 108 and 110 boot serially or boot in parallel.

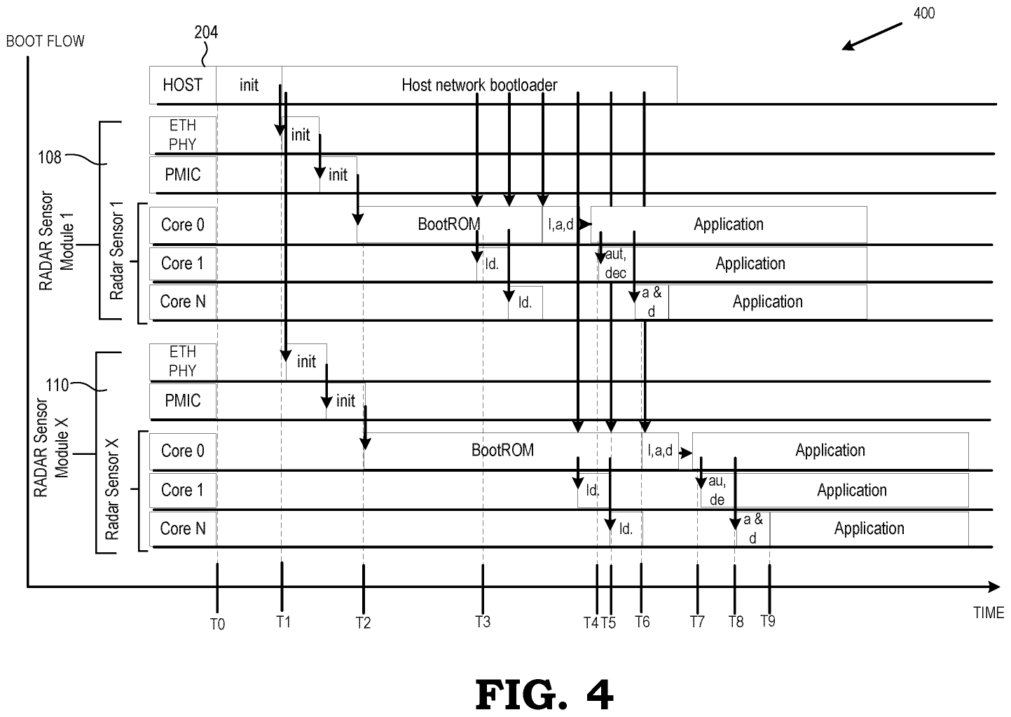

FIG. 4 illustrates a plot 400 of boot flow by a plurality of radar sensors as a function of time during booting in accordance with some embodiments. The vertical axis indicates the boot flow by a host (such as the switch 104 of FIG. 1) and radar (such as the radar sensors 108 and 110 of FIG. 1) in arbitrary units and the horizontal axis indicates the time increasing from left to right in arbitrary units. Some embodiments of the plot 400 correspond to the boot flow by the switch 104 and/or the radar sensors 108 and 110 during the booting process of the radar sensors 108 and 110 as previously described in more detail with respect to FIG. 1. For ease of illustration and description, the plot 400 only shows three cores of the multicore processing units of the radar sensors 108 and 110. However, in different embodiments, it is appreciated that more or less cores of the multicore processing units are used.

At time=T0, the switch 104 initializes in response to, for example, the autonomous motor vehicle being turned on.

At time=T1, the switch 104 initializes connection to the network 114 and ensures the communication unit of the switch 104 is active. For example, the switch 104 analyzes the communication interface of the SDWC 114 to determine it is online (i.e., operational). Additionally, the switch 104 begins the handshake process to the radar sensors 108 and 110, and connections are established between the switch 104 and the radar sensors 108 and 110 over the COM IF 108-1 and the COM IF 110-1, respectively. Also, the PMIC 102-1 manages power prior to receipt of any software by the radar sensors 108 and 110 from the switch 104.

At time=T2, the radar sensors 108 and 110 load components in response to load of a bootROM (i.e., first code for execution to identify next step for booting). In some embodiments, the bootROM is used to continue booting and execution of additional applications on the radar sensors 108 and 110.

At time=T3, the switch 104 transmits the application image, such as the AI 116 to the radar sensor 108. A first core of the multicore processing unit of the radar sensor 108 begins loading, authenticating, and decrypting the AI 116.

At time=T4, the first core of the multicore processing unit of the radar sensor 108 executes the AI 116 in response to completion of the authentication and optionally decryption.

At time=T5, a second core of the multicore processing unit of the radar sensor 108 begins authenticating and decrypting the AI 116 in serial succession after the first core of the multicore processing unit of the radar sensor 108. Also, the second core of the multicore processing unit of the radar sensor 108 executes the AI 116 in response to completion of the authentication and optionally decryption. Additionally, a first core of the multicore processing unit of the radar sensor 110 begins loading, authenticating, and decrypting the AI 117.

At time=T6, a third core of the multicore processing unit of the radar sensor 108 begins authenticating and decrypting the AI 116 in serial succession after the second core of the multicore processing unit of the radar sensor 108. Also, the third core of the multicore processing unit of the radar sensors 108 executes the AI 116 in response to completion of the authentication and optionally decryption. The radar sensor 108 begins operation related to operation of the autonomous motor vehicle in response to executing the AI 116.

At time=T7, the first core of the multicore processing unit of the radar sensor 110 executes the AI 117 in response to completion of the authentication and optionally decryption.

At time=T8, the second core of the multicore processing unit of the radar sensor 110 executes the AI 117 in response to completion of the decryption in serial succession after the first core of the multicore processing unit of the radar sensor 110. Also, a third core of the multicore processing unit of the radar sensor 110 begins authenticating and decrypting the AI 117 in serial succession after the second core of the multicore processing unit of the radar sensor 110.

At time=T9, the third core of the multicore processing unit of the radar sensor 110 executes the AI 117 in response to completion of the authentication and optionally decryption. The radar sensor 110 begins operation related to operation of the autonomous motor vehicle in response to executing the AI 117.

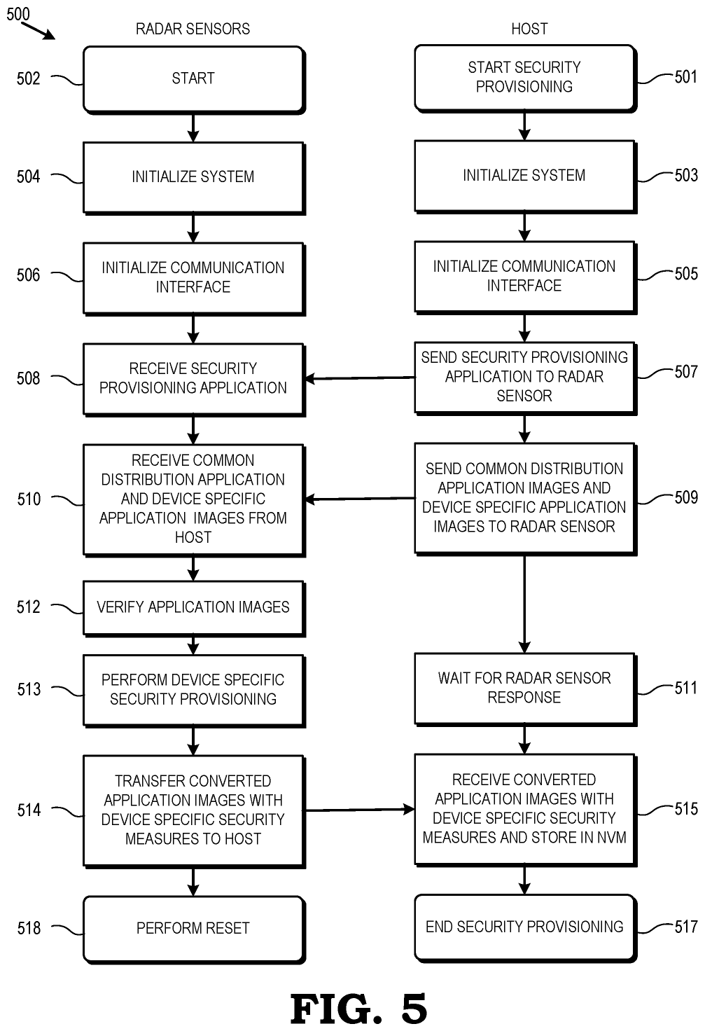

FIG. 5 is a flow diagram of a method 500 for security provisioning of radar sensors in accordance with some embodiments. For ease of illustration and description, the method 500 is described below with reference to and in an example context of the radar system 100 of FIG. 1. However, the method 500 is not limited to this example context, but instead in different embodiments, is employed for any of a variety of possible system configurations using the techniques provided herein. For example, in other embodiments, the method 500 is applied to the radar system 200 of FIG. 2 and/or the radar system 300 of FIG. 3.

The method 500 begins at block 501 with the start of the SP process by the switch 104. At block 502 the radar sensors 108 and 110 start. The radar sensors 108 and 110 are activated (i.e., turned on) in an initial state as determined by the switch 104 and/or the microcontroller of the radar using a reset signal. At block 503, the switch 104 is initialized. At block 504, the radar sensors 108 and 110 are initialized. For example, the switch 104 and the radar sensors 108 and 110 activate internal components (e.g., microcontroller and/or supporting circuitry).

At block 505, the switch 104 initiates the handshake process with the radar sensors 108 and 110 in order to establish a connection. At block 506, the radar sensors 108 and 110 receive the handshake to connect from the switch 104. At block 507, the switch 104 sends the SP application images to the radar sensors 108 and 110. At block 508, the radar sensors 108 and 110 receive the SP application images from the switch 104. At block 509, the switch 104 sends the CD application images and/or the DS application images to the radar sensors 108 and 110. At block 510, the radar sensors 108 and 110 receive the CD application images and/or the DS application images from the switch 104.

At block 511, the switch 104 remains idle while waiting for updated information from the radar sensors 108 and 110. At block 512, the radar sensors 108 and 110 verify the application images. At block 513, the radar sensors 108 and 110 begin the SP process based on the type of image used, which includes analysis of hardware within the radar sensors 108 and 110. For example, if the first option is selected, such that the CD application image is converted to a DS application image, a DS key known only by the radar sensor 108 and/or 110 is used to encrypt the DS application image converted from the CD application image. If the second option is selected, the CD application image is not converted. However, for this second option of the CD application image is not returned to the switch 104. If the third option is selected, the DS application images do not need conversion as they are already device specific. These images are not returned to the switch 104.

At block 514, for the first option where the CD application image has been converted to the DS application image, the radar sensors 108 and 110 transmit the re-authenticated and optionally re-encrypted DS application image back to the switch 104. At block 515, the switch 104 receives the re-authenticated and optionally re-encrypted application images, which includes the converted CD to DS application images. After receiving the application image, in the case of DS application images, the switch 104 identifies each application image as belonging to either the radar sensor 108 or 110, which are then stored in the memory 106 as the AI 116 and AI 117. Alternatively, in the case of CD application images, the switch 104 identifies the application image applies to the radar sensors 108 and 110. Furthermore, the NVM 106 also stores the CD application images that were not converted.

At block 517, the switch 104 ends the SP process. At block 518, the radar sensors 108 and 110 perform a reset. In particular, the radar sensors 108 and 110 reset to wait for further instructions from the switch 104. After the reset, the radar sensors 108 and 110 begin booting.

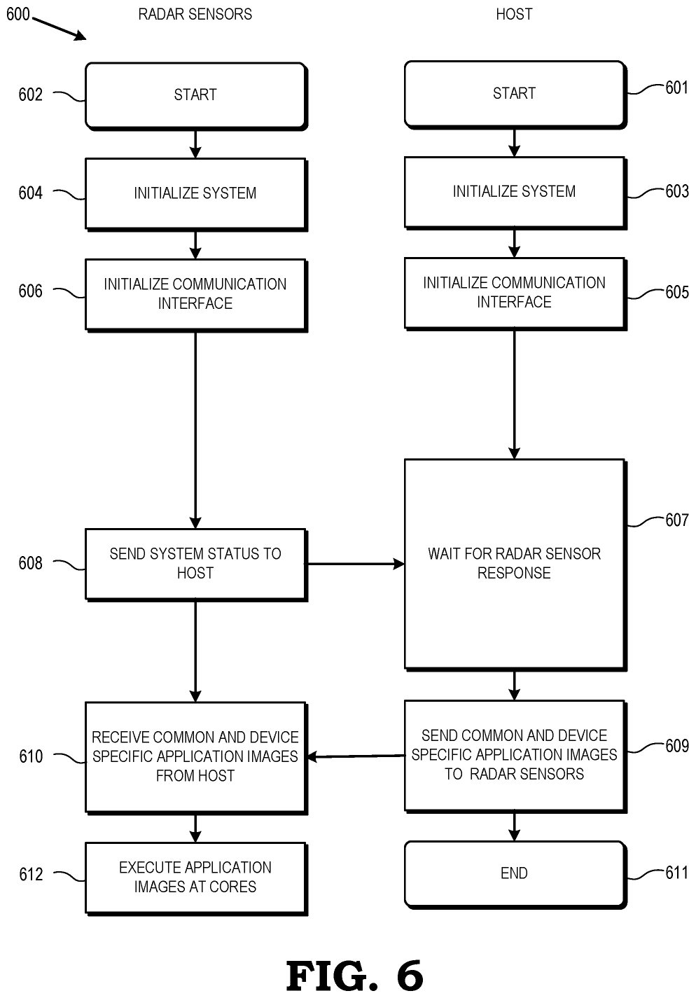

FIG. 6 is a flow diagram of a method 600 for booting radar in accordance with some embodiments. For ease of illustration and description, the method 600 is described below with reference to and in an example context of the radar system 100 of FIG. 1. However, the method 600 is not limited to this example context, but instead in different embodiments, is employed for any of a variety of possible system configurations using the techniques provided herein. For example, in other embodiments, the method 600 is applied to the radar system 200 of FIG. 2 and/or the radar system 300 of FIG. 3.

The method 600 begins at block 601 with the switch 104 beginning software distribution. At block 602, the radar sensors 108 and 110 start. The radar sensors 108 and 110 are activated (i.e., turned on) in an initial state as determined by the switch 104 and/or the microcontroller of the radar using a reset signal. At block 603, the switch 104 is initialized. At block 604, the radar sensors 108 and 110 are initialized. For example, the switch 104 and the radar sensors 108 and 110 activate internal components (e.g., microcontroller and/or supporting circuitry).

At block 605, the switch 104 initiates the handshake process with the radar sensors 108 and 110, respectively in order to establish a connection. At block 606, the COM IF 108-1 and 110-1 of the radar sensors 108 and 110 receive the handshake to connect from the switch 104.

At block 607, the switch 104 waits for updated information from the radar sensors 108 and 110.

At block 608, the radar sensors 108 and 110 update the switch 104 of system status or operational status. As such, the radar sensors 108 and 110 send a signal to the switch 104 that the radar sensors 108 and 110 are fully functional and that no errors were detected.

At block 609, the switch 104 continues the booting process by transmitting the AI 116 and the AI 117 (e.g., CD application images and/or DS application images) to the radar sensor 108 and the radar sensor 110, respectively. At block 610, upon receipt of the AI 116 by the radar sensor 108 and the AI 117 by the radar sensor 110, the radar sensors 108 and 110 verify the authenticity and when required decrypt the AI 116 and the AI 117, respectively. Each core of the multicore processing units of the radar sensors 108 and 110 initially authenticates and when required decrypts the AI 116 and the AI 117. At block 611, the switch 104 ends the booting process. Furthermore, the switch 104 may continue the booting process with another radar sensor. At block 612, each core of the multicore processing units of the radar sensors 108 and 110 execute the AI 116 and the AI 117 to operate the radar related to the motor vehicle.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at each of a plurality of radar sensors, a corresponding application image distributed from a host over a communication link of a motor vehicle; and
booting the plurality of radar sensors disposed in the motor vehicle in response to each the plurality of radar receivers receiving the corresponding application image.

2. The method of claim 1, wherein receiving comprises each of the plurality of radar sensors receiving at least one of a host image, a common distribution application image, and a device specific application images.

3. The method of claim 2, further comprising:
performing device specific security provisioning for a radar sensor of the plurality of radar sensors based on a configuration of the radar sensor.

4. The method of claim 1, wherein booting the plurality of radar sensors comprises:
booting the plurality of radar sensors serially in response to receipt of the corresponding application image over the communication link.

5. The method of claim 1, wherein booting the plurality of radar sensors comprises:
booting the plurality of radar sensors in parallel in response to receipt of the corresponding application image over the communication link.

6. A radar system comprising:
a plurality of radar sensors disposed in a motor vehicle and connected over a communication link to a host, each of the plurality of radar sensors coupled to a corresponding non-volatile memory configured to:
in response to receiving an application image in volatile memory from the host, executing the application image from the corresponding non-volatile memory.

7. The radar system of claim 6, wherein the application image is authenticated and encrypted prior to being received from the host.

8. The radar system of claim 7, wherein at least one of authentication and encryption applied to a first application image for a first of the plurality of radar sensors differs from at least one of authentication and encryption applied to a second application image for at least one second of the plurality of radar sensors based on the first application image and the second application image being common distribution application images that are converted to device specific application images after receipt by the first and the second of the plurality of radar sensors.

9. The radar system of claim 8, wherein
the authentication applied to the first of the plurality of radar sensors is based on properties of the first of the plurality of radar sensors, and
the authentication applied to the at least one second of the plurality of radar sensors is based on properties of the at least one second of the plurality of radar sensors.

10. The radar system of claim 6, wherein the plurality of radar sensors are further configured to boot serially.

11. The radar system of claim 6, wherein each of the plurality of radar sensors are further configured to boot in parallel.

12. The radar system of claim 9, wherein
a first application image for a first of the plurality of radar sensors is stored by the host, and
a second application image for at least one second of the plurality of radar sensors is stored by the host.

13. The radar system of claim 12, wherein the first application image has a different configuration than the second application image.

14. The radar system of claim 6, wherein the host is at least one of a network switch and a local host that shares a radar sensor module that includes the plurality of radar sensors.

15. The radar system of claim 6, wherein the host is a remote host disposed on a host module separate from a radar sensor module that includes the plurality of radar sensors.

16. A radar sensor module (RSM) comprising:
a plurality of radar sensors configured to detect information around a motor vehicle; and
a host connected to each of the plurality of radar sensors and configured to send a plurality of application images from a non-volatile memory connected to the host to each of the plurality of radar sensors over a communication link, such that each of the plurality of radar sensors boots from a corresponding volatile memory in response to receiving the plurality of application images.

17. The RSM of claim 16, wherein each of the plurality of radar sensors boots serially to each other radar sensor.

18. The RSM of claim 16, wherein each of the plurality of radar sensors boots in parallel to each other radar sensor.

19. The RSM of claim 16, wherein the host is at least one of a network switch and a local host that shares a radar sensor module that includes the plurality of radar sensors.

20. The RSM of claim 16, wherein the host is a remote host disposed on a host module separate from a radar sensor module that includes the plurality of radar sensors.
